(19) United States
(12) Patent Application Publication
(10) Pub. No.: US 2011/0149402 A1
(43) Pub. Date: Jun. 23, 2011

(54) DIFFUSION FILM AND PREPARATION PROCESS THEREOF

(75) Inventor: Yi-Chia WANG, Kaohsiung (TW)

(73) Assignee: ETERNAL CHEMICAL CO., LTD.

(21) Appl. No.: 12/964,872

(22) Filed: Dec. 10, 2010

(30) Foreign Application Priority Data
Dec. 18, 2009 (TW) 098143704

(51) Int. Cl. G02B 5/02; B05D 5/06; C08F 2/46; C08F 2/48

(52) U.S. Cl. 359/599; 427/162; 427/487; 427/504; 427/510

(57) ABSTRACT

The present invention relates to a diffusion film comprising a substrate with a convex-concave microstructure layer on at least one side of the substrate wherein the diffusion film has a haze of no less than 5% and a total light transmittance of no less than 50% as measured according to JIS K7136 standard method and the convex-concave microstructure layer is formed by utilizing a coating composition comprising a polymer which is composed of a material that is the same as or similar to that of the main component of the substrate and a material that is incompatible with said polymer and applying said coating composition onto said substrate.

### BACKGROUND OF THE INVENTION

1. Field of the Invention

The present invention relates to a diffusion film, and particularly to a diffusion film for use in liquid crystal displays (LCDs) and having high light diffusion and high transparency properties, and a process for preparing the diffusion film.

2. Description of the Prior Art

Generally, a main structure of LCDs includes two parts, that is, a panel and a back light module. The panel part mainly includes, for example, a transparent electrode plate, liquid crystals, an alignment film, a color filter, a polarizing plate, and a driver integrated circuit (IC), and the back light module part mainly includes, for example, a lamp, a light guide plate, and various optical films.

In order to make light uniformly distributed on a panel, a method commonly used in the industry presently is to add a diffusion film or a diffusion plate in a back light module; or to further integrate a light diffusion function to a prism film or other optical films, for example, by forming concave-convex microstructures on a surface of a reflective film or a reflective plate for providing a diffusion effect.

A conventional diffusion film or plate is mainly formed by coating a composition containing a resin binder and organic or inorganic particles as diffusing particles on a substrate to form a diffusion layer. When passing through the diffusion layer, light will be refracted, reflected, and scattered, and thus this kind of diffusion film or plate can effectively diffuse the light, such that an effect of light uniformizing is achieved. However, during formation of the diffusion layer, the diffusing particles are easily to aggregate or adhere to each other, and thereby the uniformity of the diffused light is influenced and dark spots are easily generated on the surface of a display. Moreover, if the diffusing particles are inorganic particles, because the density of the inorganic is generally higher than that of the organic resin binder, the inorganic particles are easily to precipitate in the processing process due to the gravity, such that the quality of the film is non-uniform after coating. Furthermore, the diffusing particles may fall off, and thereby influencing the optical properties of the film or plate.

Another method commonly used in the art is to form concave-convex microstructures on the surface of an optical film, light is emitted in all directions by means of the microstructures, and thus the effect of light uniformizing is achieved. One of the conventional processes that are commonly used is to print a resin onto a surface of an optical film to form desired concave-convex structures by using a mould having a concave-convex structured groove, for example, by a blasting wheel coating process. However, this process is limited by a release property between the resin and the mould. For example, when a polyester resin is used, the resin is likely to remain on the mould due to the poor release property between the resin and the printing mould, such that the fabricated concave-convex structures are not as expected, and thereby influencing the quality of the optical film.

A commonly used substrate for the optical film is formed with a polyester resin while a resin used for the diffusion layer or the concave-convex microstructures is generally an acrylate resin. If this kind of resin is directly processed onto the polyester substrate, the film is likely to warp due to a poor adhesion. In order to solve such a problem, surface treatment is generally performed on the substrate first in the industry, and then subsequent processing is performed. A commonly used surface treatment process includes corona surface treatment, plasma surface treatment, or additionally applying a primer layer on the substrate. However, the above-mentioned surface treatment processes not only increase the production cost, but also have their own restrictions. For example, the plasma treatment has the disadvantages of low speed and high cost; the corona treatment has the disadvantages that the property of a treated surface will change with time, which is unfavourable to storage; and the thickness of the primer layer will influence the adhesion of the coating layer.

Accordingly, the present invention provides a diffusion film containing no diffusing particles. The diffusion film of the present invention not only has a light diffusion property, but also improves the uniformity of light diffusion, and thus the problems in the prior art can be effectively solved. Moreover, the diffusion film of the present invention does not need an additional surface treatment step and does not need to use diffusing particles, and the adhesion between the fabricated microstructure layer and the substrate is good, and thereby the production cost is lowered, and the application value in industry is improved.

### BRIEF DESCRIPTION OF THE DRAWINGS

FIG. 1 is a micrograph of a surface microstructure of a diffusion film according to Example 1.

FIG. 2 is a micrograph of a surface microstructure of a diffusion film according to Example 2.

FIG. 3 is a micrograph of a surface microstructure of a diffusion film according to Example 3.

FIG. 4 is a micrograph of a surface microstructure of a diffusion film according to Example 4.

### DETAILED DESCRIPTION

For the above purpose, the present invention provides a diffusion film comprising a substrate and a concave-convex microstructure layer on at least one side of the substrate, wherein the diffusion film has a haze of no less than 5%, and a total light transmittance of no less than 50% as measured according to JIS K7136 standard method, and the concave-convex microstructure layer is formed by a process comprising:

(a) mixing the following components into a coating composition:
(i) a polymer composed of a material that is the same as or similar to the main component of the substrate;
(ii) a material incompatible with Component (i); and
(iii) a solvent;

(b) applying the coating composition onto at least one side of the substrate, to form a coating layer;

(c) drying the coating layer to remove Component (iii), wherein phase separation of Component (i) and Component (ii) occurs during drying; and

(d) removing Component (ii) to form concave-convex microstructures.

The present invention further provides a method for preparing a diffusion film having concave-convex microstructures, comprising:

(a) providing a substrate;

(b) mixing the following components into a coating composition:
(i) a polymer composed of a material that is the same as or similar to the main component of the substrate;
(ii) a material incompatible with Component (i); and
(iii) a solvent;

(c) applying the coating composition onto at least one side of the substrate by a coating process, to form a coating layer;

(d) drying the coating layer to remove Component (iii), wherein phase separation of Component (i) and Component (ii) occurs during drying, and optionally curing Component (ii) with an energy ray; and

(e) removing Component (ii) to form the concave-convex microstructures.

It should be noted that the terminology used in the description is for the purpose of describing the embodiments only and not intended to limit the protection scope of the present invention. For example, as used herein, the terms “a,” “an,” and “the” include singular and plural references unless the context clearly dictates otherwise.

The diffusion film of the present invention comprising a substrate and a concave-convex microstructure layer on at least one side of the substrate. The phrase “at least one side of the substrate” used herein refers to a light incident surface, a light emitting surface, or both of the surfaces of the substrate.

The substrate used in the present invention is not particularly limited and can be any substrate known to persons having ordinary skill in the art, such as a plastic substrate. The resins used to form the plastic substrate can be homopolymers or copolymers and the species of the resins are not particularly limited, and can be, for example, but are not limited to: polyester resins, such as polyethylene terephthalate (PET) and polyethylene naphthalate (PEN); polyacrylate resins, such as polymethyl methacrylate (PMMA); polyolefin resins, such as polyethylene (PE) and polypropylene (PP); polycycloolefin resins; polyimide resins; polycarbonate resins; polyurethane resins; triacetate cellulose (TAC); polylactic acid (PLA); or a mixture thereof. Polyester resins, polycarbonate resins, or a mixture thereof is preferred and polyethylene terephthalate is more preferred. In general, the thickness of the substrate is in the range from 15 μm to 300 μm, usually depending on the desired purpose of an optical product.

The concave-convex microstructures on the diffusion film of the present invention are made by the following steps:

(a) mixing the following components into a homogeneous coating composition:
(i) a polymer composed of a material that is the same as or similar to the main component of the substrate;
(ii) a material incompatible with Component (i); and
(iii) a solvent;

(b) applying the coating composition onto at least one side of the substrate, to form a coating layer;

(c) drying the coating layer to remove Component (iii), wherein phase separation of Component (i) and Component (ii) occurs during drying; and

(d) removing Component (ii) to form concave-convex microstructures.

To strengthen the adhesion between the concave-convex microstructures and the substrate, a polymer composed of a material that is the same as or similar to the main component of the substrate is used in the subject invention as Component (i). Because of the properties are the same as or similar to those of the substrate, the adhesion between Component (i) and the substrate is good, and after the removal of Component (iii), Component (i) adheres to the subject well and is hard to be peeled. Furthermore, in order to prevent that Component (i) polymerizes with Component (ii) during the curing step that makes it difficult to remove Component (ii) from Component (i) and the substrate, it is preferred that Component (i) is a polymer which will not react with Component (ii) or a saturated polymer.

After choosing the substrate, the species of Component (i) used in the present invention can be chosen from the materials having the properties same as or similar to the substrate, depending on the species of the substrate. The above properties mean the physical and/or chemical properties of a material. For example, when the substrate is formed of a polyester resin, the preferred Component (i) is a polyester resin, or other polymer with similar properties, such as an alkyd resin, or a combination thereof, and is not limited to a homopolymer or a copolymer. The above-mentioned polyester resin can be, for example, but is not limited to: an oil free polyester resin, such as a saturated polyester; or a polyester resin with a high molecular weight, of which polyethylene terephthalate (PET) and polyethylene naphthalate (PEN) are preferred. The above-mentioned alkyd resin can be, for example, but is not limited to: a long oil alkyd resin, such as a soya bean oil alkyd resin or a linseed oil alkyd resin; a medium oil alkyd resin such as a soya fatty acid alkyd resin; a short oil alkyd resin, such as a castor oil alkyd resin or a coconut fatty acid alkyd resin; or a modified alkyd resin, such as a tolylene diisocyanate (TDI) modified castor oil alkyd resin, a styrene modified alkyd resin and a epoxy ester alkyd resin. The castor oil alkyd resin and the tolylene diisocyanate modified castor oil alkyd resin are preferred and the tolylene diisocyanate modified castor oil alkyd resin is more preferred.

According to an embodiment of the present invention, the substrate is essentially formed of polyethylene terephthalate, Component (i) is a modified alkyd resin and preferably a tolylene diisocyanate modified alkyd resin.

The commercially available products suitable for the present invention as Component (i) include, for example, but are not limited to: Eterkyd®1101-M-70-5, Eterkyd®1102-M-70-5, Eterkyd®1103-M-70, Eterkyd®1106-M-70, Eterkyd®1107-M-70, Eterkyd®1105-M-55, Eterkyd®2105-M-55, Eterkyd®2105-M-70, Eterkyd®2109-M-70, Eterkyd®3304-X-70, Eterkyd®3306-X-70, Eterkyd®3403-B-65, Eterkyd®3401-XT-70, Eterkyd®1170-XM-70, Eterkyd®242-XM-60, Eterkyd®NP 1020-R-47, Eterkyd®NP1021-R-60, Eterkyd®5010-S-50, Eterkyd®5016-R-33, Eterkyd®5021-R-40, Eterkyd®5081-R-40, Eterkyd®5082-R-40, Eterkyd®5000A, Eterkyd®5051-R-60, Eterkyd®5052-R-50 and Eterkyd®5054-TS-40 produced by Eternal company; VYLON®103, VYLON®200, VYLON®220, VYLON®226, VYLON®600, VYLON®660, VYLON®GK640, VYLON®GK680 and VYLON®GK810 produced by TOYOBO company; Elitel®UE-3500, Elitel®UE-3210 and Elitel®UE-3800 produced by Unitika company; and ATR2010 and ATR2009 produced by Kao company.

Component (ii) suitable for the present invention is a material incompatible with Component (i). In the absence of a solvent, the compatibility of Components (i) and (ii) is worse and a phase separation phenomenon occurs. Hence, after drying, Component (ii) can be removed from the coating layer and Component (i) is retained on the substrate to form the concave-convex microstructures.

The species of Component (ii) suitable for the present invention can be any material known by persons having ordinary skill in the art provided that the material is incompatible with Component (i), and preferably, after drying, the adhesion force between Component (ii) and the substrate is lower than that between Component (i) and the substrate, which further facilitates the removal of Component (ii). Component (ii) can be in the form of a monomer, an oligomer, or a polymer, or a mixture thereof. According to an embodiment of the present invention, in the case that Component (i) is a polyester resin or other polymer with similar properties, Component (ii) is preferably an acrylate monomer, an acrylate oligomer or a mixture thereof and more preferably a mixture of an acrylate monomer and an acrylate oligomer.

The acrylate monomer suitable for the present invention includes, for example, but is not limited to: epoxy diacrylate, halogenated epoxy diacrylate, methyl methacrylate, isobornyl acrylate, 2-phenoxy ethyl acrylate, 2-(2-ethoxyethoxy)ethyl acrylate, lauryl acrylate, stearyl acrylate, acrylamide, acrylic acid, (meth)acrylonitrile, fluorene derivative diacrylate, biphenylepoxyethyl acrylate, 1,6-hexanediol diacrylate, tripropylene glycol diacrylate, trimethylolpropane triacrylate, pentaerythritol triacrylate, dipentaerythritol hexaacrylate (DPHA), polyethylene glycol o-phenylphenyl ether acrylate, halogenated biphenylepoxyethyl acrylate, alkoxylated epoxy diacrylate, halogenated alkoxylated epoxy diacrylate, aliphatic urethane diacrylate, aliphatic urethane hexaacrylate, aromatic urethane hexaacrylate, or a mixture thereof, of which isobornyl acrylate, 2-phenoxy ethyl acrylate, tripropylene glycol diacrylate, trimethylolpropane triacrylate, pentaerythritol triacrylate, dipentaerythritol hexaacrylate or a mixture thereof is preferred.

The commercially available acrylate monomers include, for example, but are not limited to the acrylate monomers under the trade names: EM210®, EM211®, EM221®, EM2230®, EM231®, EM235®, EM265®, EM70®, EM215®, EM218® or EM2108® produced by Eternal company.

The acrylate oligomer suitable for the present invention has a molecular weight from about 1,000 to 100,000, and the species thereof include, for example, but are not limited to: acrylate, such as 2-hydroxy-3-phenoxypropyl acrylate; methacrylate; urethane acrylate, such as aliphatic urethane acrylate, aliphatic urethane diacrylate, aliphatic urethane hexaacrylate, aromatic urethane hexaacrylate or acrylate terminated urethane; epoxy acrylate, such as bisphenol-A epoxy diacrylate or novolac epoxy acrylate; or a mixture thereof, of which acrylate, methacrylate, aliphatic urethane acrylate, aliphatic urethane diacrylate, aliphatic urethane hexaacrylate, aromatic urethane hexaacrylate, bisphenol-A epoxy diacrylate or a mixture thereof is preferred.

The commercially available acrylate oligomers include, for example, but are not limited to the acrylate oligomers under the trade names: SR454®, SR494®, SR9020®, SR9021® or SR9041® produced by Sartomer company; 6101-100®, 611A-85®, 6112-100®, 6113®, 6114®, 6123®, 6131®, 6144-100®, 6145-100®, 6150-100®, 6160B-70®, 621A-80® or 621-100® produced by Eternal company; and Ebecryl 600®, Ebecryl 830®, Ebecryl 3605® or Ebecryl 6700® produced by UCB company.

The weight ratio (R_{w}) of Component (i) to Component (ii) in the coating composition of the present invention is defined below:

$${R}_{w} = \frac{{W}_{i}}{{W}_{ii}}$$

wherein Wᵢ, is the weight of Component (i), and Wᵢᵢ is the weight of Component (ii). R_{w} may be used to adjust the roughness (or the height difference of the concave-convex microstructures) of the concave-convex microstructure layer of the diffusion film of the present invention, and thereby controlling the light scattering effect of the fabricated diffusion film. For example, according to an embodiment of the present invention, Component (i) is a modified alkyd resin, Component (ii) is a mixture of an acrylate monomer and an acrylate oligomer, and R_{w} is preferably in the range of about 0.1 to about 0.8, and more preferably in the range of 0.15 to about 0.6. In this embodiment, if R_{w} is lower than 0.1, the content of Component (i) is too low, and thus the density of the protrusions formed on the substrate surface is too sparse and the protrusions are too small, such that the light scattering effect required by the present invention cannot be achieved; and if R_{w} is greater than 0.8, a continuous plane is formed on the substrate surface with Component (i), and thus the surface roughness is insufficient, such that the required light scattering effect cannot be achieved.

According to an embodiment of the present invention, Component (i) has a specific gravity greater than that of Component (ii). In this embodiment, because the specific gravity of Component (i) is greater than that of Component (ii), Component (i) is more easily to settle during the processes of forming the coating layer and removing the solvent by drying. Therefore, Component (i) can not only be effectively adhered to the substrate to improve the use efficiency, but also lower a contact area between Component (ii) and the substrate, and thus facilitating the peeling of Component (ii) from the substrate. According to a preferred embodiment of the present invention, the specific gravity of Component (i) is about 1.25 to about 1.4, and the specific gravity of Component (ii) is about 0.8 to about 1.2. According to another embodiment of the present invention, the adhesion force between Component (ii) and the substrate is lower than that between Component (i) and the substrate, which further facilitates the removal of Component (ii).

In order to make the coating composition uniformly coated on the substrate, Component (iii) used in the present invention is a solvent capable of dissolving both Component (i) and Component (ii) to generate a homogeneous phase. The inventor of the present invention found through theoretical analysis and extensive research that, the solvent for dissolving Component (i) and Component (ii) may be selected based on the following principles: 1. principle of similar polarity; 2. principle of similar solubility parameter; and 3. principle of solvation. Generally, Component (i) and Component (ii) have a solubility parameter and/or polarity similar to that of Component (iii) respectively, and in this case, Component (iii) is capable of easily and effectively dissolving Component (i) and Component (ii), to form a homogeneous phase solution. For example, if Component (i) is selected to be a tolylene diisocyanate modified alkyd resin having a solubility parameter of about 8.7 (cal/cm³)^{0.5} to about 11.1 (cal/cm³)^{0.5}, and Component (ii) is selected to be a mixture of an acrylate monomer and an acrylate oligomer having a solubility parameter of about 8.8 (cal/cm³)^{0.5} to about 9.9 (cal/cm³)^{0.5}, a solvent having a solubility parameter ranged between those of Component (i) and Component (ii), or similar to those of Component (i) and Component (ii) may be selected as Component (iii), which includes, for example, but is not limited to, xylene solvent (solubility parameter: 8.8 (cal/cm³)^{0.5}), toluene solvent (solubility parameter: 8.9 (cal/cm³)^{0.5}) or methylethyl ketone solvent (solubility parameter: 9.3 (cal/cm³)^{0.5}).

Solvation means that an interaction force between a solute and solvent molecules is greater than that between the solute molecules, such that the solute molecules are separated from each other and dissolved in the solvent. Therefore, if a strong dipole-dipole interaction is generated between Component (i)/(ii) and Component (iii), solvation will occur. In other words, the molecules of Component (iii) interact respectively with the molecules of Components (i) and (ii), when the interaction forces are greater than the own cohesive forces of Components (i) and (ii), Component (iii) is capable of dissolving Components (i) and (ii).

In the present invention, a suitable solvent may be selected as Component (iii) depending on the species of Components (i) and (ii). For example, when Component (i) is a modified alkyd resin and Component (ii) is a mixture of an acrylate monomer and an acrylate oligomer, the solvent (iii) may be a benzene solvent, an ester solvent, a ketone solvent, or a mixture thereof. The benzene solvent includes, for example, but is not limited to, benzene, toluene, o-xylene, m-xylene, p-xylene, trimethylbenzene, styrene, or a mixture thereof. The ester solvent includes, for example, but is not limited to, ethyl acetate, butyl acetate, diethyl carbonate, ethyl formate, methyl acetate, ethoxyethyl acetate, ethoxypropyl acetate, propylene glycol monomethyl ether ester, or a mixture thereof. The ketone solvent includes, for example, but is not limited to, acetone, methyl ethyl ketone, methyl isobutyl ketone, or a mixture thereof.

The coating composition of the present invention may optionally include any additive known to persons having ordinary skill in the art, which includes, for example, but is not limited to, an antistatic agent, a hardening agent, a photo initiator, a fluorescent whitening agent, a UV absorber, inorganic particulates, a wetting agent, a defoamer, a flatting agent, a levelling agent, a slipping agent, a dispersant, and a stabilizer.

According to an embodiment of the present invention, the coating composition of the present invention further includes a photo initiator. The photo initiator useful in the present invention is one capable of generating free radicals when being irradiated with light and initiating polymerization through transferring the free radicals, and includes, for example, but is not limited to, benzophenone, benzoin, benzil, 2,2-dimethoxy-1,2-diphenylethan-1-one, 1-hydroxy cyclohexyl phenyl ketone, 2,4,6-trimethylbenzoyl diphenyl phosphine oxide (TPO), or a combination thereof.

The solid content of the coating composition of the present invention is generally about 15 wt % to about 75 wt %, and preferably about 30 wt % to about 65 wt %, based on the total weight of the coating composition. When the solid content is lower than 15 wt %, a phenomenon of drooping fluid easily occurs due to the excessively low solid content; and when the solid content is greater than 75 wt %, disadvantages of an excessively high viscosity and poor coating properties are easily caused due to the excessively high solid content.

The coating composition of the present invention may be prepared by any process known to persons having ordinary skill in the art, and formulated in a suitable environment according to the difference of the components. According to an embodiment of the present invention, the coating composition of the present invention is prepared by fully mixing each component at about 25° C.

The coating composition is applied onto a substrate to form a coating layer by a process well known to persons having ordinary skill in the art, which includes, for example, but is not limited to, knife coating, roller coating, micro gravure coating, flow coating, dip coating, spray coating, and curtain coating. According to an embodiment of the present invention, the coating process is roller coating.

After coating, the solvent is removed from the coating layer by drying in the present invention. Because the solvent is removed during drying, phase separation occurs between Component (i) and Component (ii) due to the incompatibility therebetween; therefore, Component (ii) is removed from the coating layer after drying such that concave-convex microstructures based on Component (i) remain on the substrate. The drying temperature and time may be determined depending on the species of the solvent. According to an embodiment of the present invention, the drying temperature is about 60° C. to about 140° C., and preferably about 100° C. to about 120° C., and the drying time is about 10 s to about 80 s, and preferably 20 s to about 60 s.

Moreover, in order to further facilitate the peeling of Component (ii), especially when Component (ii) is in the form of monomer or oligomer, in the present invention, Component (ii) is optionally cured using an energy ray after removing the solvent, and then peeled from the coating layer. The energy ray may be any energy ray known to persons having ordinary skill in the art, for example, but is not limited to, thermal energy, radiant energy, and electron beam, and two or more energy rays may be used simultaneously or sequentially to perform curing. The radiant energy includes IR light, visible light, UV light, and laser. According to an embodiment of the present invention, the curing process is UV curing, in which the irradiation intensity may be 100 mJ/cm² to 1000 mJ/cm², and preferably 200 mJ/cm² to 800 mJ/cm².

As described above, the surface roughness of the fabricated concave-convex microstructure layer or the height difference of the concave-convex microstructures may be adjusted by the weight ratio of Component (i) to Component (ii) in the coating composition, to obtain better light scattering effect. Furthermore, the surface roughness of the fabricated concave-convex microstructure layer or the height difference of the concave-convex microstructures may be adjusted by controlling the process conditions, for example, drying temperature or time. According to an embodiment of the present invention, the arithmetic mean roughness (Ra) of the concave-convex microstructure layer is about 0.2 μm to about 2 μm, and preferably about 0.4 μm to 1.5 μm, and the ten-point mean roughness (Rz) is about 2 μm to about 12 μm, and preferably about 3 μm to about 7 μm.

Besides applying the coating composition on a plastic substrate to fabricate the concave-convex microstructures, the diffusion film of the present invention may be made by using a conventional optical film (for example, a diffusion reflective film, a brightness enhance film, a reflective polarizing film, or any optical film in need of light uniformizing function) as a substrate and further processing the substrate to fabricate the concave-convex microstructures, and thereby improving the light diffusion effect of the film.

As measured according to JIS K7136 standard method, the diffusion film of the present invention has a haze of no less than 5%, and preferably in the range of about 15% to about 75%; and a total light transmittance of no less than 50%, and preferably in the range of about 70% to about 95%.

According to an embodiment of the present invention, the diffusion film of the present invention contains a polyethylene terephthalate substrate, and at least one side of the substrate includes a concave-convex microstructure layer, wherein the concave-convex microstructure layer is formed by a phase separation process as described in the present invention and composed of a tolylene diisocyanate modified alkyd resin; and the diffusion film has a haze of no less than 5% and a total light transmittance of no less than 50% as measured according to JIS K7136 standard method.

The diffusion film of the present invention does not need an additional surface treatment step, and the adhesion between the fabricated microstructure layer and the substrate is still good, and thus the production cost is lowered, and the application value in industry is improved. Due to its concave-convex microstructures, the diffusion film fabricated in the present invention can be used in a light source device, for example, a back light module of LCDs, to provide light diffusion effect. The concave-convex microstructures may be located at a light emitting surface, a light incident surface of the substrate, or both, with the light emitting surface of the substrate being preferred. Moreover, the diffusion film of the present invention does not contain diffusing particles, and thus influence on the uniformity of the diffused light caused by aggregation or adhesion of the diffusing particles is avoided, and problems caused by settling or falling off of the diffusing particles are solved.

The embodiments below are provided for further illustrating the present invention, instead of limiting the scope of the present invention. Modifications and variations easily made by persons having ordinary skill in the art fall within the scope of the disclosure of the specification and the claims of the present invention.

### Preparation Example 1

To a 250 ml glass flask, 30.0 g of dipentaerythritol hexaacrylate, 6.0 g of trimethylol propane triacrylate, 42.0 g of pentaerythritol triacrylate, 84.0 g of an aliphatic urethane hexaacrylate (Etercure 6145-100, Eternal Company), and 18.0 g of 1-hydroxylcyclohexylbenzyl ketone as photo initiator were added sequentially, to finally prepare a mixture having a solid content of 100% and a total weight of about 180 g.

### Preparation Example 2

To a 100 ml glass flask, 46.5 g of toluene solvent as Component (iii), 26.6 g of a mixture of Preparation Example 1 as Component (ii) and photo initiator, and 26.6 g of tolylene diisocyanate modified castor oil alkyd resin (Eterkyd 5010-S-50, Eternal Company, solid content of about 50%) as Component (i) were added sequentially, to finally prepare a clear and transparent coating composition having a solid content of 40% and a total weight of about 100 g.

### Preparation Example 3

To a 100 ml glass flask, 52.0 g of toluene solvent as Component (iii), 32.0 g of the mixture of Preparation Example 1 as Component (ii) and photo initiator, and 16.0 g of tolylene diisocyanate modified castor oil alkyd resin (Eterkyd 5010-S-50, Eternal Company, solid content of about 50%) as Component (i) were added sequentially, to finally prepare a clear and transparent coating composition having a solid content of 40% and a total weight of about 100 g.

### Preparation Example 4

To a 100 ml glass flask, 54.4 g of toluene solvent as Component (iii), 34.2 g of the mixture of Preparation Example 1 as Component (ii) and photo initiator, and 11.4 g of tolylene diisocyanate modified castor oil alkyd resin (Eterkyd 5010-S-50, Eternal Company, solid content of about 50%) as Component (i) were added sequentially, to finally prepare a clear and transparent coating composition having a solid content of 40% and a total weight of about 100 g.

### Example 1

The coating composition prepared in Preparation Example 2 was coated onto a surface of a transparent PET substrate [TAIRILIN BH116, Nanya Plastics Corporation] having a thickness of 188 μm with a RDS coating bar #8, to form a coating layer. The coating layer was dried for 1 min at 100° C. to remove the solvent, and cured with an energy ray of 200 mJ/cm² on a UV exposure machine [Fusion UV, F600V, 600 W/inch, H type lamp], and then a tape [Scotch #610, 3M Company] was pasted on the coating surface to peel off the cured Component (ii), to prepare a diffusion film having concave-convex microstructures and having a total thickness of 190 μm.

### Example 2

The same process of Example 1 was used, except that the solvent was removed by drying for 30 s at 110° C., to prepare a diffusion film having concave-convex microstructures and having a total thickness of 190 μm.

### Example 3

The same process of Example 1 was used, except that the coating composition prepared in Preparation Example 3 was used, to prepare a diffusion film having concave-convex microstructures and having a total thickness of 190 μm.

### Example 4

The same process of Example 1 was used, except that the coating composition prepared in Preparation Example 4 was used, to prepare a diffusion film having concave-convex microstructures and having a total thickness of 190 μm.

### Comparative Example 1

Tolylene diisocyanate modified castor oil alkyd resin (Eterkyd 5010-S-50, Eternal Company, solid content of about 50%) was coated onto a surface of a transparent PET substrate [TAIRILIN BH116, Nanya Plastics Corporation] having a thickness of 188 μm with a RDS coating bar #8, and dried for 1 min at 100° C. to remove the solvent, to prepare a diffusion film having a total thickness of 190 μm.

### Comparative Example 2

The mixture of Preparation Example 1 was coated onto a surface of a transparent PET substrate [TAIRILIN BH116, Nanya Plastics Corporation] having a thickness of 188 μm, and then cured with an energy ray of 200 mJ/cm² on a UV exposure machine [Fusion UV, F600V, 600 W/inch, H type lamp], to finally prepare a diffusion film having a total thickness of 190 μm.

### Comparative Example 3

Tolylene diisocyanate modified castor oil alkyd resin (Eterkyd 5010-S-50, Eternal Company, solid content of about 50%) was coated onto a surface of a transparent PET substrate [TAIRILIN BH116, Nanya Plastics Corporation] having a thickness of 188 μm with a blasting processed roller having concave-convex structured notches thereon, and dried for 1 min at 100° C. to remove the solvent, to finally prepare a diffusion film having an average thickness of 190 μm.

### Test Methods

Film thickness test: the film thickness of a test coating layer was measured in a 1 N press-contact manner using a film thickness gauge (model PIM-100, TESA Company).

Haze/Total light transmittance test: the haze (Hz %) and the total light transmittance (Tt %) of the test coating layer were measured with a haze meter (model NDH 5000 W, Nippon Denshoku Industries Co., Ltd) according to JIS K-7136 standard method. The test results are as shown in Table 1 below.

Surface roughness test: the arithmetic mean roughness (Ra, unit: μm) and ten-point mean roughness (Rz, unit: μm) of the test coating layer were measured with a roughness meter [model Surftest SJ-201, Mitsutoyo Company] according to JIS B-0601 standard method. The test results are as shown in Table 1 below.

Adhesion test: the surface of the coating layer was scratched with a cross hatch cutter [model Cross-cut Guide CCJ-1, CHUO SEIMITSU KIKI Company], and then a tape was pasted, and peeled at 90°, to determine a number of the peeled grids. The adhesion of the test coating layer to the PET substrate was measured according to JIS K-5400 standard method. The test results are as shown in Table 1 below.

TABLE 1
Property comparison of diffusion films
of examples and comparative examples

| | Weight ratio (R_{w}) | | | | | |
|---|---|---|---|---|---|---|
| | of Component (i) | | | Adhesion | | |
| | to Component (ii) | Hz % | Tt % | test | Ra | Rz |
| Example 1 | 0.56 | 60.12 | 89.15 | No | 0.51 | 3.77 |
| | | | | falling off | | |
| Example 2 | 0.56 | 70.77 | 91.33 | No | 0.85 | 5.45 |
| | | | | falling off | | |
| Example 3 | 0.28 | 33.04 | 89.14 | No | 1.11 | 5.42 |
| | | | | falling off | | |
| Example 4 | 0.19 | 17.35 | 89.13 | No | 0.47 | 5.11 |
| | | | | falling off | | |
| Comparative | 1/0 | 2.30 | 88.19 | No | — | — |
| Example 1 | | | | falling off | | |
| Comparative | 0/1 | 2.50 | 89.42 | Coating | — | — |
| Example 2 | | | | falling off | | |
| Comparative | 1/0 | — | — | — | — | — |
| Example 3 | | | | | | |

*In Comparative Example 3, a part of resin remained on the roller during the coating process, and thus resulted in coating failure.

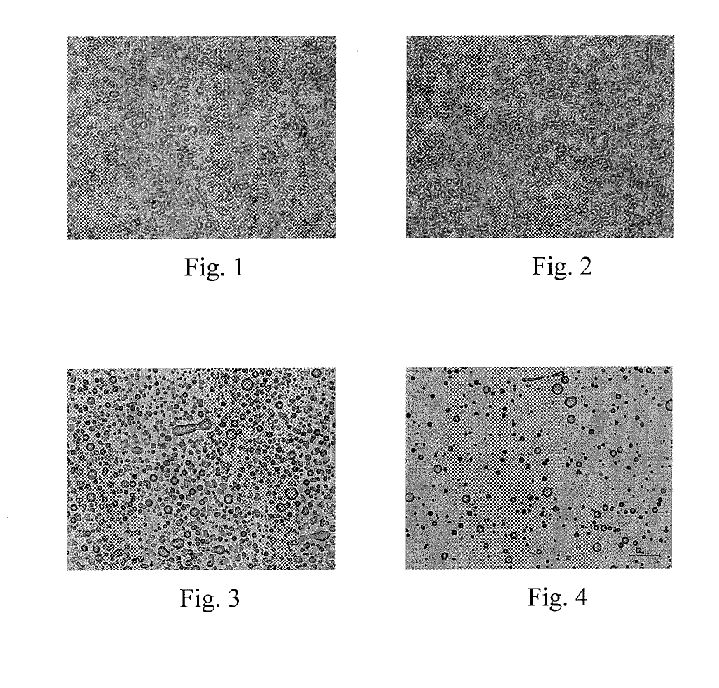

The surface microstructures of the diffusion films of Examples 1 to 4 were observed with an optical microscope respectively. The obtained micrographs are as shown in FIGS. 1 to 4. It can be known from FIGS. 1 to 4 that, the lower the proportion of Component (i) is, the sparser the density of the concave-convex parts of the prepared diffusion film is.

It can be known from the results of Examples 1 to 4 that, the weight ratio of Component (i) to Component (ii) influences the haze and the total light transmittance of the diffusion film. The lower the proportion of Component (i) is, the lower the haze of the fabricated diffusion film is. Therefore, various diffusion films having different hazes and total light transmittances can be prepared by adjusting the ratio of Component (i) to Component (ii), depending on the needs in practical applications.

It can be known from the results of Examples 1 and 2 that, in Examples 1 and 2, the same coating composition is used, but in the latter, drying is carried for a shorter time at a higher temperature, and the prepared diffusion film has a higher haze. Therefore, the diffusion property of the diffusion film can be controlled by controlling process parameters such as drying temperature and/or time, in addition to by adjusting the ratio of Component (i) to Component (ii), such that the diffusion film may meet the needs of practical applications more desirably.

The properties of the transparent PET substrate used in Examples 1 to 4 are similar to those of the material of Component (i), and thus the adhesion is good, all of the test coating layers pass the adhesion tests, and no falling off of the concave-convex microstructure layer from the substrate occurs.

It can be known from Table 1 that, the diffusion films of Comparative Examples 1 and 2 have a coating layer formed with Component (i) or Component (ii), but no obvious concave-convex microstructures generated on the surface thereof. Thus, the hazes of the films are only 2.3% and 2.5%, respectively, such that they cannot provide enough light diffusion effect. Moreover, the coating layer of Comparative Example 1 is formed with Component (i), the property of the material is similar to that of the substrate, and thus the adhesion is good and the coating layer can pass the adhesion test; by contrast, the coating layer of Comparative Example 2 is formed with Component (ii), the adhesion of the coating layer with the substrate is poor after curing, and the coating layer completely fell off after adhesion test.

We claim:

1. A diffusion film, comprising a substrate and a concave-convex microstructure layer on at least one side of the substrate, wherein the diffusion film has a haze of no less than 5%, and a total light transmittance of no less than 50% as measured according to JIS K7136 standard method, and the concave-convex microstructure layer is formed by a process comprising:
(a) mixing the following components into a coating composition:
(i) a polymer composed of a material that is the same as or similar to the main component of the substrate;
(ii) a material incompatible with Component (i); and
(iii) a solvent;
(b) applying the coating composition onto at least one side of the substrate to form a coating layer;
(c) drying the coating layer to remove Component (iii), where phase separation occurs between Component (i) and Component (ii) during drying; and
(d) removing Component (ii) to form concave-convex microstructures.

2. The diffusion film according to claim 1, wherein the process for forming the concave-convex microstructure layer further comprises: curing Component (ii) with an energy ray after Step (c) and before Step (d).

3. The diffusion film according to claim 1, wherein the substrate is a plastic substrate and is selected from the group consisting of a polyester resin, a polyacrylate resin, a polyolefin resin, a polycycloolefin resin, a polyimide resin, a polycarbonate resin, a polyurethane resin, cellulose triacetate, polylactic acid, and a combination thereof.

4. The diffusion film according to claim 1, wherein the substrate is a polyester resin, and Component (i) is a polyester resin, an alkyd resin, or a mixture thereof.

5. The diffusion film according to claim 4, wherein the substrate is polyethylene terephthalate, and Component (i) is a tolylene diisocyanate modified alkyd resin.

6. The diffusion film according to claim 4, wherein Component (ii) is selected from the group consisting of an acrylate monomer, an acrylate oligomer, an acrylate polymer, and a combination thereof.

7. The diffusion film according to claim 1, wherein the coating composition further comprises an additive.

8. The diffusion film according to claim 1, wherein the weight ratio of Component (i) to Component (ii) is in the range of 0.1 to 0.8.

9. The diffusion film according to claim 1, wherein the specific gravity of Component (i) is greater than that of Component (ii).

10. The diffusion film according to claim 6, wherein Component (iii) is a benzene, an ester, a ketone, or a mixture thereof.

11. The diffusion film according to claim 1, having a haze in the range of 15% to 75%, and a total light transmittance in the range of 70% to 95% as measured according to JIS K7136 standard method.

12. A method for preparing a diffusion film having concave-convex microstructures, comprising:
(a) providing a substrate;
(b) mixing the following components into a coating composition:
(i) a polymer composed of a material that is the same as or similar to the main component of the substrate;
(ii) a material incompatible with Component (i); and
(iii) a solvent;
(c) applying the coating composition onto at least one side of the substrate by a coating process to form a coating layer;
(d) drying the coating layer to remove Component (iii), where phase separation occurs between Component (i) and Component (ii) during drying; and
(e) removing Component (ii) to form the concave-convex microstructures.

13. The method according to claim 12, wherein the coating process is selected from the group consisting of knife coating, roller coating, micro gravure coating, flow coating, dip coating, spray coating, and curtain coating.

14. The method according to claim 13, wherein the coating process is roller coating.

15. The process according to claim 12, further comprising curing Component (ii) with an energy ray after Step (d) and before Step (e).

16. The method according to claim 15, wherein the energy ray is selected from the group consisting of thermal energy, radiant energy, electron beam, and a combination thereof.

17. The method according to claim 15, wherein the energy ray is UV light.

18. A diffusion film, comprising a polyethylene terephthalate substrate having a concave-convex microstructure layer on at least one side thereof, wherein the concave-convex microstructure layer is formed by a phase separation process and composed of a tolylene diisocyanate modified alkyd resin, and the diffusion film has a haze of no less than 5% and a total light transmittance of no less than 50% as measured according to JIS K7136 standard method.
